(19) United States
(12) Patent Application Publication
(10) Pub. No.: US 2003/0016243 A1
(43) Pub. Date: Jan. 23, 2003

(54) Provision of kiosk functionality through personal computers

(76) Inventor: Aravinda Korala, Edinburgh (GB)

Correspondence Address: SALTAMAR INNOVATIONS, 30 FERN LANE, SOUTH PORTLAND, ME, 04106, US

(21) Appl. No.: 09/911,165

(22) Filed: Jul. 23, 2001

(51) Int. Cl. G09G 5/00

(52) U.S. Cl. 345/741

(57) ABSTRACT

A method for enabling a user of a personal computer to access web applications in an easy to use, kiosk-like environment where access to the normal desktop environment is blocked and where certain key presses and popup windows are blocked. On initialization, the user is given the choice of entering the normal desktop environment or accessing a web application in the easy to use, kiosk-like environment.

### FIELD OF INVENTION

The invention relates to the provision of a dedicated web commerce mode on personal computers.

### BACKGROUND TO THE INVENTION

In recent years, increased home ownership of Internet connected personal computers (PCs) has lead to increased usage of on-line services in general and financial services in particular. For example, home PC users may purchase goods and services over the Internet or carry out financial and banking transactions such as setting up, checking and maintaining bank accounts, paying bills or transferring money between accounts. Within the specification and claims, the term personal computer and abbreviation PC refers to any standalone computer for personal use and includes personal digital assistants and mobile computers. Most PCs are computers for home use running an operating system such as Windows®, Unix, Linux or MacOS®.

However, at the present time, many people who are not regular computer users find personal computers difficult to use. In particular, the flexibility of modern desktop user interfaces means that inexperienced users frequently make errors, starting up unwanted functionality, receiving error messages they do not understand and causing the computer to enter states from which they cannot easily return to correct operation of their desired web commerce application.

The problems with current systems are illustrated with reference to FIGS. 1 and 2. FIG. 1 illustrates a typical personal computer 1 comprising a processing unit 2, a monitor 3, input peripherals such as a keyboard 4 and mouse 5 communicating through an Internet connection 6 to a remote web server 7. Personal computers 1 typically have an operating system providing a desktop user interface, for example Microsoft® Windows® NT, 1995, 1998, 2000 or ME, OS/2 Warp®, MacOS® or Unix or Linux running X Window System. A desktop user interface has the ability to display one or more windows associated with applications on a screen and enables a user to organise data and launch applications through selections made with a pointing device such as a mouse or touch screen.

FIG. 2 illustrates a screen image 10 typical of what is shown on a monitor 3 during the delivery of web commerce through personal computers. Active window 11 is a browser window displaying web pages downloaded from a remote server 7. The browser window will remain active as long as the user does not select screen controls or windows outside the browser window. However, if the user clicks on other locations, for example, icons 12, web pages 13, menu bar functions 14 or even elsewhere on desktop 10 they may activate other programs or de-activate active window 11 causing confusion to novice users who may not know how to deal with application or functions they have triggered or understand why the deactivated window no longer functions as before. Furthermore, active window 11 will typically comprise a number of menus 15 providing an array of options to users which are not directly relevant to the application they are using and which can lead to them selecting inappropriate options.

Furthermore, a user may press key combinations which interrupt or change program function, for example CTRL-ALT-DEL, ALT-F4 or ALT-TAB in a Microsoft® Windows® environment. Furthermore, before and during use of web commerce, events may happen which provide confusing results; for example, if a web server is not available, a web browser such as Internet Explorer® 5.5 will produce an explanation that the page cannot be displayed. This often confuses novice users. Many other events, such as an Internet connection being interrupted, will lead to pop-up boxes being displayed which again provide users with requirements to make decisions on issues that they do not understand or which were not envisaged by the designers of the web server 7.

The aim of the present invention is to enable a user who is not technically confident to safely and simply use web commerce on a personal computer, particularly a home PC.

Several approaches to this problem are known in the field of self-service kiosks. Self-service kiosks include, for example, public Internet access terminals which allow a user to access the Internet in a controlled environment. Self-service kiosks typically run web browsers such that menu bars are suppressed and the browser takes up the whole screen, so that there is no way a user may inadvertently de-select the active window or access system functions through a point and click interface.

However, there needs to be a way for a kiosk software support engineer to exit this application and so a typical self-service kiosk will have, for example, a plug-in keyboard or an operator switch on a kiosk stand which switches the system into a mode enabling the self-service kiosk to be altered by a software support engineer. It is also known for a self-service kiosk to respond to a customised series of key presses or mouse clicks, not having any particular meaning to the underlying operating system and then prompt for a password and allow access to certain functions available only to authorized personnel. Some self-service kiosks have buttons such as CTRL, ALT and function keys removed to avoid users pressing certain key combinations. These systems intend to prevent the actual user of a web commerce application being able to access other functions on the self-service kiosk.

The invention aims to make it as easy as possible for non-expert users to access web commerce applications through personal computers.

Public arena self-service kiosks often enable users to carry out only one of a selection of web commerce functions. Whereas self-service kiosks enable a user to access web commerce facilities specifically chosen by the kiosk operator, the invention aims to allow users to access web commerce facilities of their choice.

It is known, for example in computer games, to suppress key combinations which interrupt program function and this is also known in the field of public arena self-service kiosks. However, No known art of such actions was found in the field of web commerce delivery on home PC's. In particular, an aim of this invention is to guide a user into a secure fault tolerant environment for web commerce and then to exit such an environment at an appropriate time, returning the computer to its normal customisable function. This is in substantial contrast to the use of a public self-service kiosk where a web commerce user is at no time able to customise the function of the kiosk itself.

Therefore, the invention aims to provide a method and apparatus enabling a personal computer to deliver easy to use web commerce to private users, enabling them to choose between the flexibility of their personal computer and a convenient and easy to use mode with many of the benefits of a self-service kiosk.

### BRIEF DESCRIPTION OF THE INVENTION

According to a first aspect, the present invention provides a method of providing access by a personal computer to internet servers, the method comprising the steps of:

enabling a user to choose between at least a first and a second option, wherein said selection occurs during initialization of a user interface program executed on said computer and adapted to enable a user of the computer to activate applications;

the first option allowing the user interface program to be executed, enabling a user of the computer to activate applications;

the second option causing a web browser to be activated, the web browser enabling a user to access at least one internet server without enabling a user to activate applications through the user interface program.

Therefore, a user can choose between normal use of their personal computer and an alternate mode for accessing web applications on internet servers in which the user cannot accidentally activate other applications.

In a second aspect, there is provided a method of providing access by a personal computer to internet servers, the method comprising the steps of:

causing a web browser to be activated responsive to a user selection, the web browser enabling a user to access at least one internet server;

preventing a user from interrupting web browser function by entering a selected user input, said step of preventing performed by monitoring user input and trapping said selected user input;

determining that a user has completed a user interaction with the internet server; and

cancelling said trapping.

Therefore, from when a user makes a selection, the user can use an internet server, but cannot interrupt web browser function by pressing one or more keys on the keyboard. This mode persists under program control, for example until it is determined that a user has completed their interaction with the internet server.

A third aspect provides a method of providing access by a personal computer to internet servers, the method comprising the steps of:

causing a web browser to be activated responsive to a user selection, the web browser enabling a user to access at least one internet server and providing content displayed in a window on a screen;

preventing a user from interrupting web browser function by would interrupt web browser function by causing said window to cover all screen regions which would otherwise enable a user to interrupt browser function by selecting a part of said regions;

determining that a user has completed a user interaction with the internet server; and

closing said window or web browser application.

Therefore, once a user has made their selection, they can access an internet server through a web browser but cannot, by selecting a portion of the screen with a user interface peripheral such as a mouse, interrupt browser function until it is determined that the user has completed an interaction with the internet server.

According to a fourth aspect of the present invention there is provided a method of providing access by a personal computer to internet servers, the personal computer having an operating system adapted to display pop-up windows in response to events, the method comprising the steps of:

causing a web browser to be activated responsive to a user selection, the web browser enabling a user to access at least one internet server;

setting up a software trap responsive to display or attempted display by the operating system of pop-up windows;

performing an action on said pop-up windows selected from a list of actions comprising: cancelling, changing and replacing said pop-up windows

determining that a user has completed a user interaction with the internet server; and

cancelling said software trap.

Therefore, from when a user makes their selection until it is determined that the user has completed an interaction with the internet server, popup windows can be cancelled, change to more readily understandable forms or replaced with different user interface elements, ensuring a user is not faced with confusing messages or asked to make decisions they do not understand during web transaction.

### BRIEF DESCRIPTION OF THE SEVERAL DRAWINGS

An example embodiment of the present invention will now be illustrated with references to the following figures in which:—

FIG. 1 is a schematic diagram of a personal computer;

FIG. 2 is a screen display of a known method for delivering web commerce;

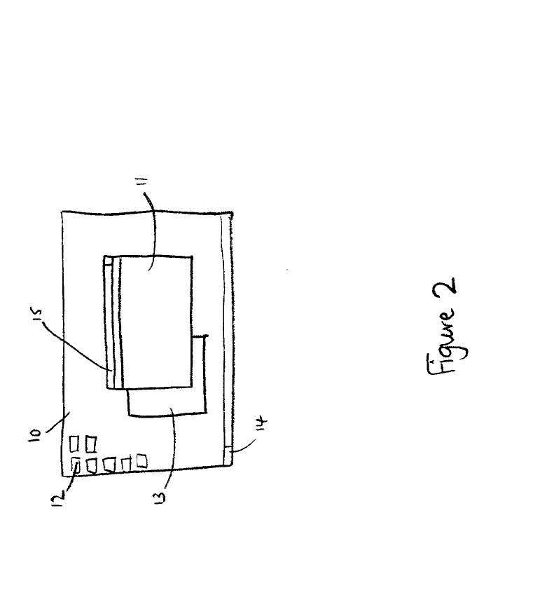

FIG. 3 is an example screen of an initial display in accordance with one aspect of the present invention.

FIG. 4 is an example function selection page in a web commerce application;

FIG. 5 is an option selection page in a web commerce application in accordance with an aspect of the present invention;

FIG. 6 is a data entry page in a web commerce application;

FIG. 7 depicts a preferred embodiment of a flow chart illustrating through a control method of the present invention; and

FIG. 8 illustrated preferred major components of the software application of the present invention.

### DETAILED DESCRIPTION OF THE EXAMPLE EMBODIMENT

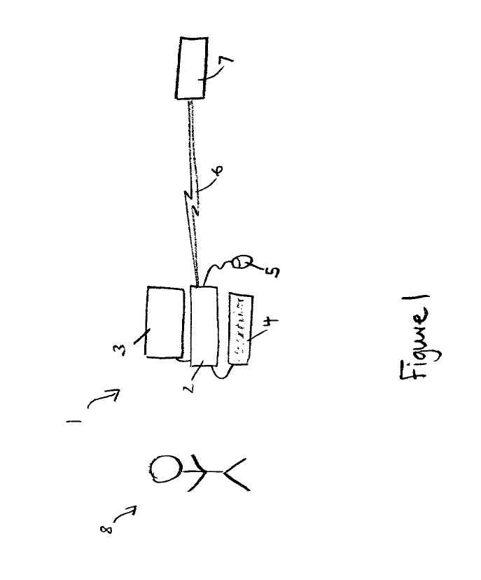

FIG. 1 illustrates a personal computer 1 comprising a processing unit 2, a monitor 3, input peripherals such as a keyboard 4 and mouse 5 communicating through an Internet connection 6 to a remote web server 7. Preferably, the personal computer 1 runs an operating system providing a desktop user interface. Example operating systems providing such an interface include Microsoft® Windows® NT, 1995, 1998, 2000 or ME, OS/2 Warp®, MacOS® or Unix or Linux running the X Window System. Typically, the operating system provides functions used by a desktop system, for example, setting up and displaying windows, but the desktop is controlled by a separate desktop control application, such as explorer.exe in Windows NT®. Unless otherwise specified or clear to a person skilled in the art in light of the context, the word ‘desktop’ in this application, should be considered to mean the whole or any portion or subset of the screen or collection of screens, windows, and interface elements available for the user not through any particular application but as a general operating system interface, in a manner generally akin to the Microsoft Windows® desktop metaphor. Equivalently, it refers to a computing environment derived by the combination of screens, icons, and such user interface elements.

On a personal computer, once a desktop environment has been started up, after identifying themself if required, a user has the ability to activate applications stored on or accessible to the computer 1. This is in sharp contrast to a self-service kiosk in which only a software support engineer can access applications on the computer. The user of web commerce applications on a self-service kiosk does not have the freedom to start up additional applications started on the computer or to change computer settings. Applications stored on or accessible to the computer (for example, being stored on a network server) are distinguished from applications executed on a web server 7 or downloaded from a server in the course of web browsing and executed within the confines of web browser function.

A common feature of operating systems is the provision of a standardised initialisation routine when the operating system is initialised. For example, in Windows NT® a user is asked to log on, providing a user name and, optionally, password. In other environments, an operating system runs through a series of initialisation routines, executing applications intended for being run during initialisation and then provides access to a desktop environment. Initialising may also include rebooting an operating system, switching user identity in a multi-user operating system environment or switching on or re-starting a computer.

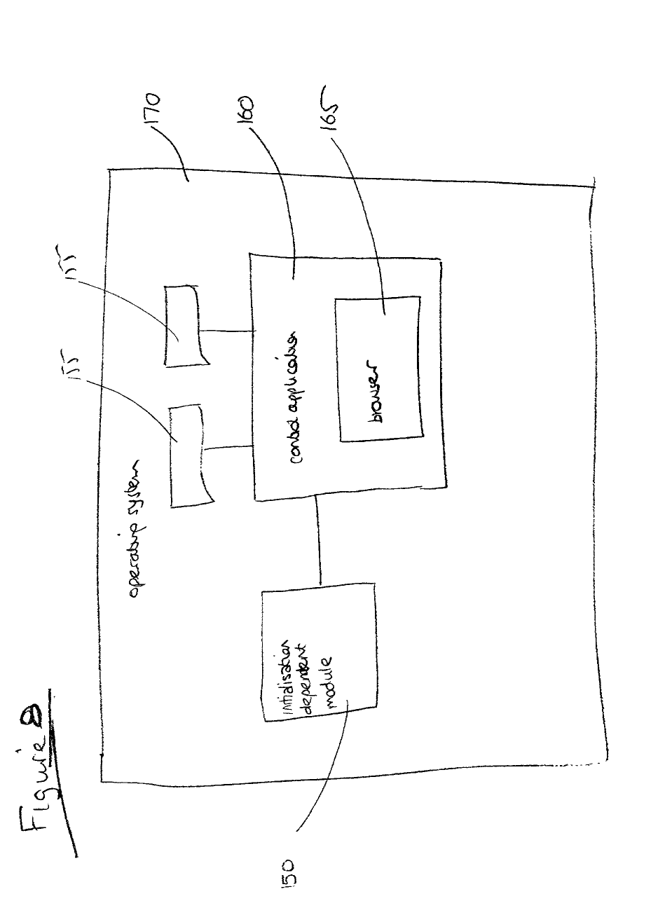

FIG. 8 illustrates the principal components of the software application of the preferred embodiment. An initialisation dependent module 150 is executed on initialisation of the operating system and a control application 160 runs within the operating system 170. A web browser 165 is provided and is preferably, but not essentially, a component within control application 160. A suitable web browser component 165 is Internet Explorer® web browser component from Microsoft® of Redmond, Wash. One or more data sets 155 discussed further below specify information pertaining to individual web applications, for example, the URL of an initial web page. The control application 160 directs the browser component 165 to download and execute the initial web page when an individual web application is started up. Data sets 155 may specify additional information as discussed below.

The method by which initialisation dependent module 150 is started upon operating system initialisation varies between operating systems. For example, Windows NT® looks up and executes a stored reference to a login process which is, by default, explorer.exe which administers the desktop. However, this reference can be replaced by initialisation dependent module 150 or a further program which call initialisation dependent module 150. If the login process is explorer.exe, then applications can be added instead to the “Startup” folder on the Start Menu. In a Unix or Linux environment a login process can be specified by editing an entry specific to the user in a file used by the operating system. Additionally, each user has facilities for running commands automatically upon start up. In this case, the login process can be amended to the initialisation dependent module 150. Other variations are known and the process of causing an initialisation dependent module 150 to execute on initialisation can be readily carried out by one skilled in the art.

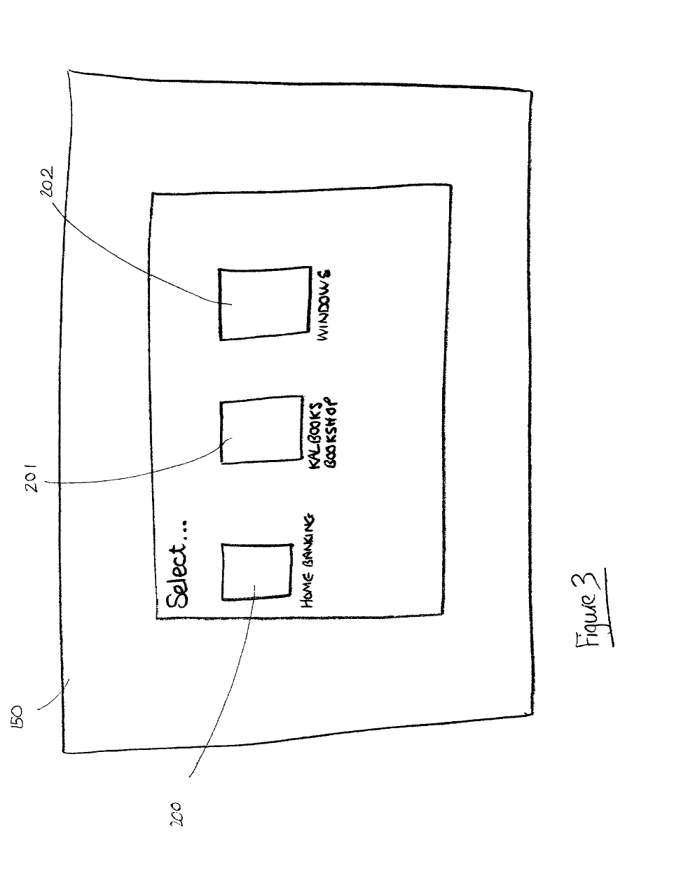

FIG. 3 illustrates an example of the options given to the user by initialisation dependent module 150. Different methods known in the art may be used to enable a user to select from a range of options. In this example, clicking on some selections activates web commerce applications, here home banking 200 or a bookshop service 201. At least one other selection completes initialisation of the operating system, allowing access to normal desktop functionality, for example by starting explorer.exe in a Windows NT® environment. In an operating system adapted to prompt a user to identify themselves through a text user identification, a user may enter his/her username for the operating system to access normal desktop functionality or, instead, a particular keyword to enter a particular web commerce application. For example, entering “home banking” as a user identification to enter a home banking web commerce application. In accordance with a preferred embodiment of the present invention, at least one option activates an application such as web commerce application and at least one option allows a user to access the default, desktop, environment.

Preferably, although a user selecting a web commerce application will not be presented with an opportunity to use normal function of an operating system desktop 10, the web commerce application will still run within the confines of that operating system. In the preferred embodiment, the operating system user interface features are used, but the desktop is not started up. For example, on a Windows NT® system, explorer.exe would not be initialised but operating system graphic user interface routines would be called by control program 160. For example, the web commerce application can be executed within a browser window and may use hidden windows for execution of web pages containing additional functions; however, the user will be given no opportunity to select other windows, click outside the active window or select certain system menus.

In an alternative embodiment, the desktop is initialised but the user is prevented from switching to other windows, selecting any system menus or clicking outside the active window by either causing the active window to obscure the entire screen or trapping mouse clicks or key combinations which would switch to another window or deactivate the main window.

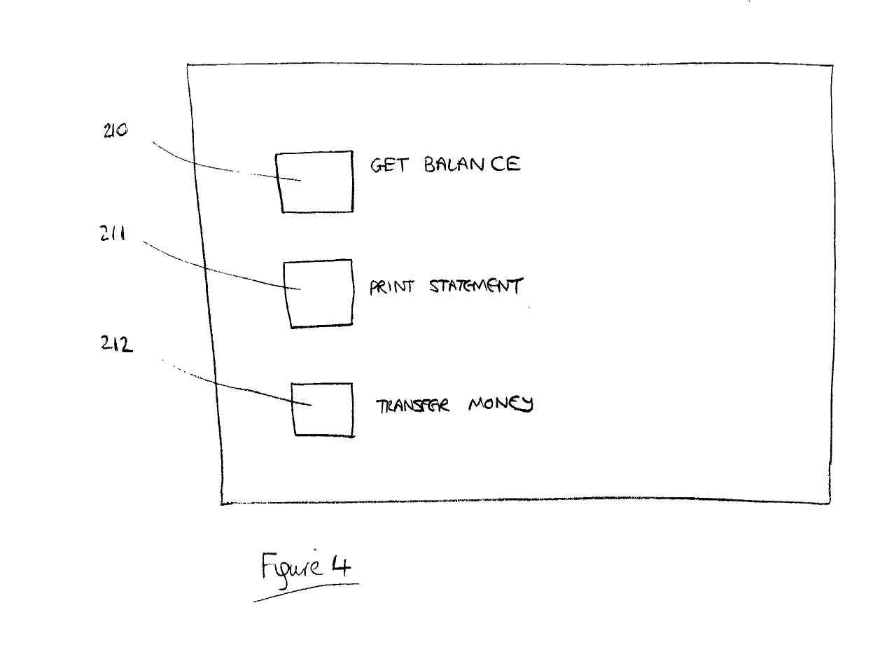

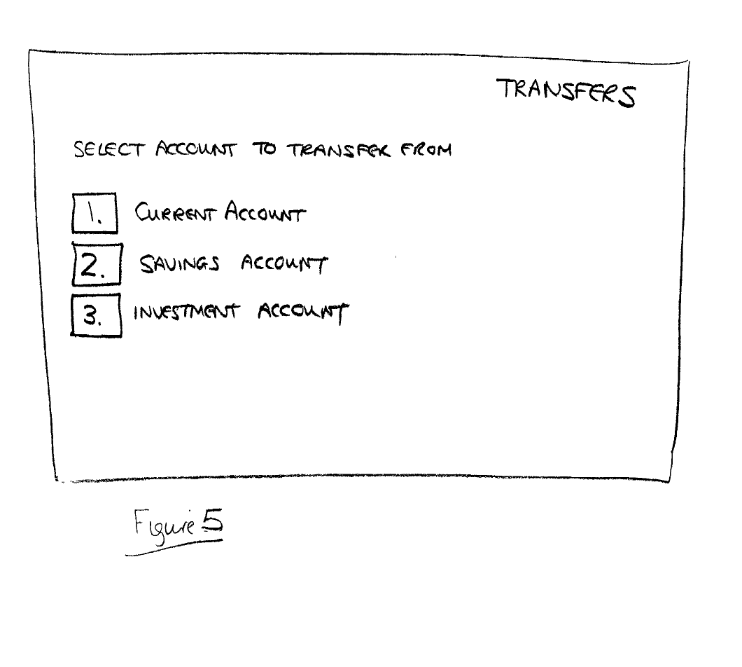

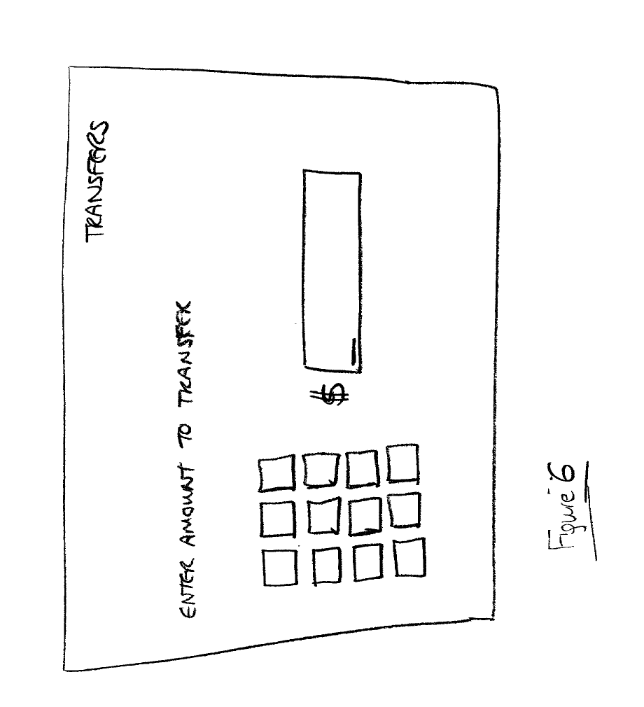

FIGS. 4 to 6 illustrate screens provided to a user in an example application executed in response to selection of the home banking option 200. FIG. 4 illustrates the screen providing three options pertaining to financial accounts: get balance 210, print a statement 211, or transfer money 212 between accounts. On selection of transfer money 212 the user is then presented with another screen as illustrated in FIG. 5 from which they can choose an account from which to transfer money. After selecting an account the user is presented with a further screen illustrated in FIG. 6 where he/she can enter an amount to transfer using the keyboard or by mouse clicks on buttons provided. Finally, when the transactions are completed the user is returned to the initialisation screen 150 from which he/she can access another web commerce application or return to the operating system. Each screen in FIGS. 4 to 6 preferably constitutes an HTML page executed by a browser running in full-screen mode, without browser menus and selecting certain individual options results in an HTTP request being sent to a remote server 7 from which a new web page is retrieved as is conventional in the art.

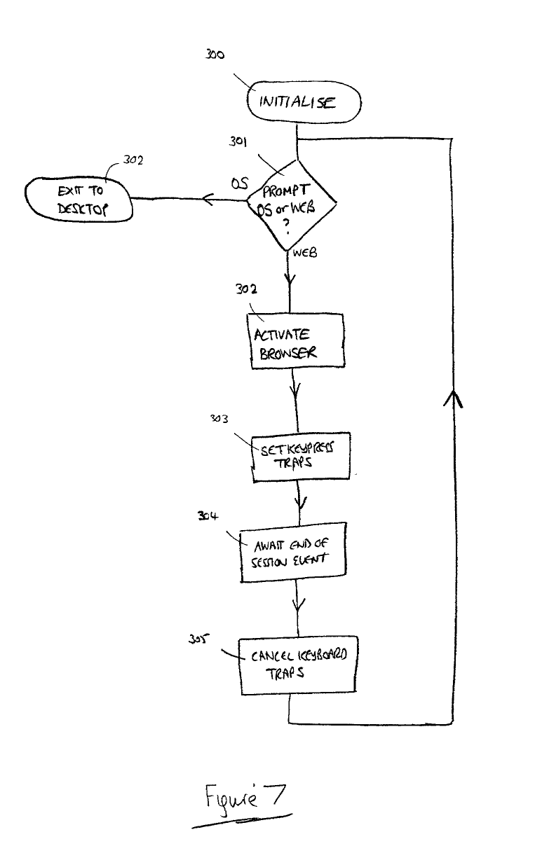

FIG. 7 is a flow chart illustrating the control of application flow in the present invention. After initialisation 300, the user is prompted to make a selection between at least one option triggering a web commerce application and at least one operating system or other common computer environment in which case the initialisation control module 150 exits allowing the computer to prepare a working environment such as a desktop.

If a web commerce application is selected, the control application 160 and web browser 165 are activated 302. Next, the software traps are set up 303 to ignore key press combinations which interrupt flow of a web browsing activity. Web browser 165 is activated in full screen mode with menus disabled. These functions are preferably carried out by the control application but could be carried out by the initialisation control module 300, or even by a method called from within a downloaded web page. Thereafter, a user interacts with browser 165 to access the chosen web commerce application. Finally, the end of a user session is detected 304 whereupon the keyboard software traps are cancelled 305 and the application returns to the initialisation control module 150. Cancellation of keyboard software traps may instead be carried out by the initialisation control module 150 or a method called from within a downloaded web page.

The end of a session may be determined by selecting a button present in the frame of the active browser window or a button present in a displayed web page. A dialogue box asking a user whether they wish to end a session can also be displayed when a particular event is identified, for example, a user browsing back to a start page. In the controlled environment provided by the present invention orderly termination of transactions, such as rollback or other operations needed to insure transaction integrity, may be performed as needed.

Therefore, the invention can be seen as providing a secure, easy to use mode on a personal computer, started up in response to a user selection and finished when it is determined that a user wishes to leave the mode or has completed a particular session.

During a web application execution several alterations to normal browser function are implemented by the control application 160. Firstly, the browser component 165 is run with no browser menus available to the user and occupying the full screen area. In general, rather than occupying the full screen area it need only obscure all screen regions which, if selected, would interrupt or alter browser function. The required or full screen area can be obscured not just by the part of the browser window within which content is displayed but also any border to the browser window or other windows or displayed graphics which cover other regions of the screen. In an alternative embodiment, the window does not cover the entire screen area but is merely adapted so that clicking outside the browser window does not call any operating system functions and does not send any events to desktop control functions of the operating system. This could be achieved by trapping all mouse clicks and voiding all clicks outside the active screen area.

Furthermore, certain key combinations are trapped. In a Windows® environment these will typically be CTRL-ALT-DEL and ALT-F4 and ALT-TAB. Preferably, key presses and key combinations carrying out browser functions are also trapped, for example, Internet Explorer running in kiosk mode typically allows a user to enter a new location by typing CTRL-L or to print a documents using CTRL-P, these functions are both disabled in the present invention. A user can move to other locations only by selecting links on the screen and can print only by selecting a print icon on the screen or by automatic function executed by the web browser when executing a web page.

Pop up message boxes issued by the operating system are also trapped, preferably at the same time that key combinations are trapped. Message boxes are often displayed for example, in windowed operating systems to inform the user of script errors, connection failures and other related issues. When message boxes are generated by the operating system, they are trapped and replaced with a simple, easy to understand message or, preferably, are never displayed. These are trapped by the control program 160. Software traps can be set up in a Windows® environment using the SetWindowsHookEx Win32 API call with the argument WH_KEYBOARD. Popup windows can be trapped in a Windows ® environment using the SetWindowsHookEx Win32 API call with the argument WH_CALLWNDPROCRET. Alternative methods for other operating systems will be apparent to one skilled in the art. Key and popup window traps can also be set using the Kalignite® KXKeyboardTrap and KXPopup controls available from KAL of Edinburgh, Scotland.

In the preferred embodiment, it is not possible during use of the web commerce application, to access any of the other programs which are installed on the computer or other operating system capabilities. In a preferred embodiment, navigation between sites takes place only in response to a user clicking on links displayed in a web page or through selecting links displayed by control program 160, these links navigating directly to specified pages.

Different combinations of key trapping, popup dialogue trapping and preventing a user from accessing other operating system functionality through selecting particular parts of the screen can be included combined or separately in different embodiments.

Data sets 155 provide information pertaining to particular web applications. Firstly, they specify the web application which is to be accessed. It the preferred embodiment, a data set 155 contains a start URL of a page which the control program 160 initially directs the browser to download. A data set 155 may also specify other software components, customisations, private data, additional visual elements and the like to be started up by the control application 160 when the web application is selected. A data set 155 preferably includes a list of URLs which define a set of web pages a user may visit. A more detailed description of an appropriate data set 155 is found in U.S. application Ser. No. 09/870,057 where an example of a suitable data set is known as a siteset. U.S. application Ser. No. 09/870,057 is hereby incorporated by reference.

In the case where only one data set 155 is provided, the web application specified by that data set 155 is activated automatically on initialisation. When multiple data sets 155 are available, a screen is displayed as in FIG. 3 illustrating the various options available and providing an icon to access each image, or a default operation is taken. The initialisation dependent module 150 or control application 160 can also check automatically for downloads such as, new images and updated images corresponding to particular sites. Preferably, the download is carried out without requiring any guidance or input from the user and without interrupting web commerce application function.

Furthermore, customisation pertaining to particular web applications can be stored on the home PC or downloaded from the web commerce server 7. This allows additional user interface elements to be displayed on screen, for example buttons which navigate directly to particular parts of a web site, help buttons, additional graphics and branding. Furthermore, these customisations preferably define a set of URLs which can be accessed thereby preventing the user from browsing to an unauthorised site whilst using the web commerce application

In an alternative embodiment the browser control application is launched in a more conventional application by selecting an icon on the desktop. The browsing control application runs again in kiosk mode filling the full screen and protecting the browsing environment as described above. In this case, when the program exits, for example, by clicking on a quit button on the interface the application terminates by the user remains logged into the operating system account.

Optionally, some standard operating system or desktop functionality can be retained: for example, the ability to access the systems task bar start menu or the ability to use ALT-TAB to switch between applications or ALT-F4 to interrupt applications.

The system is particularly easy to use by users of little or no experience using a PC. All they require to do is to select a particular application and a log on prompt and thereafter use of a mouse and keyboard is all that is required to use web applications. In particular, preventing users from selecting other applications or interrupting application function and preventing display of confusing dialogue boxes makes the system particularly easy to use.

The invention has therefore provided a simple and convenient way to deliver web commerce applications to users of home PCs by restricting their ability to customise the PC, make alterations, deactivate active windows or start applications which would cause confusion whilst a web commerce application is being used. The safe and simple environment provided makes it easy for unsophisticated computer users to benefit from web commerce applications. In many ways, the user's personal computer behaves like a web commerce appliance, delivering many of the benefits of a self-service kiosk without sacrificing the flexibility of personal computer ownership. Furthermore, a user can choose between multiple web commerce applications and can install applications of their own choice, not being limited to the specific applications usually available to a user of a public arena self-service kiosk.

In the preferred embodiment, the same interface is displayed as is provided to ATMs and kiosks in the public arena providing the same facility. For example, where a banking application is delivered by the method of the present invention, the interface may correspond with that of the banks ATMs. In another embodiment, the user interface simulates that of an organisation self-service kiosks, perhaps adding graphics for features not found on a home PC. For example, buttons not present on a personal computer may be displayed on screen and selected by clicking and devices which are not present on a personal computer can be simulated by providing a visual simulation of their function.

The invention extends to computer programs in the form of source code, object code, code intermediate sources (such as in a partially compiled form), or in any other form suitable for use in the implementation of the invention. Computer programs may be standalone applications, software components or plug-ins to other applications. Computer programs may be web pages. Computer programs may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for download across the Internet from a server. Computer programs may also be embedded in an integrated circuit.

Further modifications and alterations may be made within the scope of the invention herein described.

What is claimed is:

1. A method of providing access by a personal computer to internet servers, the method comprising the steps of:
enabling a user to choose between at least a first and a second option, wherein said selection occurs during initialization of a user interface program executed on said computer and adapted to enable a user of the computer to activate applications;
the first option allowing the user interface program to be executed, enabling a user of the computer to activate applications;
the second option causing a web browser to be activated, the web browser enabling a user to access at least one internet server while preventing the user from activating applications through the user interface program.

2. The method of claim 1 wherein a user interface program comprises a desktop control program and the desktop control program is only initialised upon a user selection of said first option.

3. The method of claim 1 wherein a user interface program comprises a desktop control program which, when activated, enables a user to select applications by selecting parts of a screen display, the method further comprising the step of preventing a user from selecting windows other than the desktop window associated with the web browser by causing the desktop window associated with the web browser to obscure all parts of the screen display which would select another window.

4. The method of claim 1 wherein selection of said second option results in an additional step comprising of disabling menus provided by said web browser.

5. The method of claim 1 wherein selection of said second option results in an additional step comprising of trapping dialogue boxes and cancelling or amending said dialogue boxes.

6. The method of claim 1 wherein selection of said second option results in additional steps comprising of trapping key presses, disallowing or providing alternate functionality to key presses which if not trapped, would cause the user interface program to activate applications other than said web browser.

7. The method of claim 1 further comprising the step of causing a web browser to download a specified web page stored in a data set.

8. The method of claim 1 further comprising the step of determining that a user has completed a session of using said web application and re-enabling a user to choose between at least the first and second options.

9. The method of claim 1 further comprising the step of determining that a user has completed a session of using said web application and ending said method, enabling a user of the computer to activate applications.

10. A method of providing access by a personal computer to internet servers, the method comprising the steps of:
causing a web browser to be activated responsive to a user selection, the web browser enabling a user to access at least one internet server;
preventing a user from interrupting web browser function by entering a selected user input, said step of preventing performed by monitoring user input and trapping said selected user input
determining that a user has completed a user interaction with the internet server; and
cancelling said trapping.

11. The method of claim 10 further comprising the step of causing a web browser to download a specified web page stored in a data set.

12. The method of claim 10 further comprising the step of determining that a user has completed a session of using a web application and re-enabling a user to choose between at least the first and second options.

13. A method of providing access by a personal computer to internet servers, the method comprising the steps of:
causing a web browser to be activated responsive to a user selection, the web browser enabling a user to access at least one internet server and providing content displayed in a window on a screen;
preventing a user from interrupting web browser function by causing said window to cover all screen regions which would enable a user to interrupt browser function by selecting a part of said regions;
determining that a user has completed a user interaction with the internet server; and
closing said window or web browser application.

14. The method of claim 13 further comprising the step of causing a web browser to download a specified web page stored in a data set.

15. The method of claim 13 further comprising the step of determining that a user has completed a session of using a web application and re-enabling a user to choose between at least the first and second options.

16. A method of providing access by a personal computer to internet servers, the personal computer having an operating system adapted to display pop-up windows in response to events, the method comprising the steps of:
causing a web browser to be activated responsive to a user selection, the web browser enabling a user to access at least one internet server;
setting up a software trap responsive to display or attempted display by the operating system of pop-up windows;
performing an action on said pop-up windows selected from a list of actions comprising cancelling, changing or replacing said pop-up windows
determining that a user has completed a user interaction with the internet server; and
deactivating said software trap.

17. The method of claim 16 further comprising the step of causing a web browser to download a specified web page stored in a data set.

18. The method of claim 16 further comprising the step of determining that a user has completed a session of using a web application and re-enabling a user to choose between at least the first and second options.

19. A method of providing access by a personal computer to internet servers, the method comprising the steps of:
enabling a user to choose between at least a first and a second option, wherein said selection occurs during initialization of a user interface program executed on said computer and adapted to enable a user of the computer to activate applications;
the first option allowing the user interface program to be executed, enabling a user of the computer to activate applications;
the second option causing a web browser to be activated, the web browser enabling a user to access at least one internet server while preventing a user from activating applications through the user interface program, wherein said user interface program comprises a desktop control program which, when activated, enables a user to select applications by selecting parts of a screen display, the second option further comprising the steps of:
preventing a user from selecting windows other than the desktop window associated with the web browser by causing the desktop window associated with the web browser to obscure all parts of the screen display which would select another window; and
subsequently determining that a user has completed a session of using a web application and ending the method, enabling a user of the computer to activate applications

20. A method of providing access by a personal computer to internet servers, the method comprising the steps of:
enabling a user to choose between at least a first and a second option, wherein said selection occurs during initialization of a user interface program executed on said computer and adapted to enable a user of the computer to activate applications;
the first option allowing the user interface program to be executed, enabling a user of the computer to activate applications;
the second option causing a web browser to be activated, the web browser enabling a user to access at least one internet server while preventing a user from activating applications through the user interface program, wherein said user interface program comprises a desktop control program which, when activated, enables a user to select applications by selecting parts of a screen display, the second option further comprising the steps of:
preventing a user from selecting windows other than the desktop window associated with the web browser by causing the desktop window associated with the web browser to obscure all parts of the screen display which would select another window;
disabling menus provided by said web browser;
trapping one or more key press combination, disallowing or providing alternative functionality to key presses which would cause the user interface program to activate applications other than the web browser; and
subsequently determining that a user has completed a session of using a web application and ending the method, enabling a user of the computer to activate applications.
